(19) United States
(12) Patent Application Publication
(10) Pub. No.: US 2008/0169346 A1
(43) Pub. Date: Jul. 17, 2008

(54) Device and method for marking a transport container with a destination address

(75) Inventors: Juergen Schad, Konstanz (DE); Helmut Kast, Allensbach (DE); Wolf-Stephan Wilke, Konstanz (DE)

Correspondence Address: SIEMENS SCHWEIZ AG;I-47, INTELLECTUAL PROPERTY, ALBISRIEDERSTRASSE 245, ZURICH, CH-8047, omitted

(73) Assignee: Siemens Aktiengesellschaft, Munich (DE)

(21) Appl. No.: 12/002,950

(22) Filed: Dec. 18, 2007

(30) Foreign Application Priority Data
Dec. 22, 2006 (DE) 102006061135.7

(51) Int. Cl. G06K 7/00; G06F 12/00; G06K 19/067; B07C 5/36

(52) U.S. Cl. 235/439; 700/227; 209/546; 235/492

(57) ABSTRACT

A device for applying a predetermined destination address to a transport container configured to transport an object has an electronic label storing the destination address, a holding device attached to the transport container to hold the electronic label during transport, a transmission facility for transmitting the destination address to the electronic label and for storing the destination address in the label, and a fixed receiving component for receiving one of the labels. The receiving component is disposed in such a manner that the transmission facility is able to transmit the destination address to each of the labels, when the label is received by the fixed receiving component. The label is removable from the holding device.

### CROSS-REFERENCE TO RELATED APPLICATIONS

The present application claims priority to German application no. DE 10 2006 061 135.7, filed Dec. 22, 2006, which is hereby incorporated by reference.

### BACKGROUND OF THE INVENTION

The invention relates to a device and method for applying a predetermined destination address to a transport container. The transport container is used to transport an object in the transport container to a predetermined destination address.

It is known that a transport container can be provided with a label, on which the destination address is printed or written. The label is a piece of paper or a plate, for example.

Logistics service providers, for example, use reusable transport containers, which after being transported to one destination address are transported to a further destination address. Using standard labels has the disadvantage that they have to be replaced or at least overwritten after transport to one destination address. Electronic labels have been developed for this reason, as disclosed in DE 102004037363 A1.

A transport container containing mail items bears an electronic label. To write the label, the container is moved into a specific position. A generation means generates information for the label, a transmission means transmits this information to the label, where it is stored. The transmission means is integrated, for example, in a hand-held device, moved by an operator into the vicinity of the container and held there until the information is transmitted to the label.

The label described in DE 102004037363 A1 is able to display information in a form that a person can read. In some situations it takes 20 to 30 seconds to transmit information to the label in such a manner that the label displays it in a readable form.

The transmission facility frequently transmits the information to the label in a contactless and wireless manner. Excessive transmit power can have an adverse effect on an operator's health. The known arrangement has the further disadvantage that during the transmission process the operator cannot carry out any further work on the container, in particular said operator is unable to load it or unload it. This is significant when the transmission time is 20 to 30 seconds long.

### SUMMARY OF THE INVENTION

An object of the invention is to provide a device and method for applying a predetermined destination address to a transport container, which allow the transport container to be loaded during the transmission process.

Accordingly, one aspect involves a device for applying a predetermined destination address to a transport container configured to transport an object. The device has at least one electronic label to store the destination address, a holding device attached to the transport container to hold the electronic label during transport, a transmission facility for transmitting the destination address to the electronic label and for storing the destination address in the label, and a fixed receiving component for receiving one of the labels. The receiving component is disposed in such a manner that the transmission facility is able to transmit the destination address to each of the labels, when the label is received by the fixed receiving component. The at least one label is removable from the holding device, and the transmission facility is a fixed device.

The inventive device is configured to store a predetermined destination address for a transport container. The destination address can be stored in an electronic label. The transport container, in which the object can be transported, has a holding device. The label can be inserted into this holding device. The holding device holds the label, while the transport container containing the object is transported.

The label can be removed from the holding device. According to the invention the device has a receiving component to receive the label. This receiving component is not attached to the transport container but is fixed. The device also has a fixed transmission facility. This transmission facility is configured to transmit a predetermined destination address to a label, which is located in the fixed receiving component.

The invention provides for the label being separated from the container while the transmission facility stores the destination address on the label. This refinement makes it possible to use the time required to store the destination address to load the container with the object at the same time. This parallel working saves time compared with serial working.

It is frequently desirable for the transmission facility to transmit the destination address to the electronic label in a contactless manner. This also means that it is not necessary, in the case of a fixed receiving component, to position the label to be written precisely, as would be necessary with any other type of transmission.

The invention allows the transmission facility to be disposed so far away from the holding device of the container that the radiation of the transmission facility does not endanger the health of an operator loading the container.

When loading the container an operator does not have to ensure that the transmission facility is located near to the holding device. This would be necessary if the label were in the holding device when the destination address was being stored.

A number of receiving components are preferably provided. The transmission facility is then able to transmit a destination address to a label, when the label is in one of the receiving components.

It is preferably checked automatically whether the transport container has actually been provided with an electronic label, after an object has been placed in the transport container. To this end a container sensor and a label sensor are provided. The container sensor senses whether or not a transport container is present at a predetermined location for loading. The container sensor does not necessarily identify a specific transport container but only whether or not any transport container is present at this location. The label sensor senses whether or not a label is present in the receiving component. The label sensor also does not necessarily identify a specific label but only whether any label is present in the receiving component.

By evaluating the measured values from the two sensors it is automatically identified whether or not a transport container has been removed from the loading point. If so, a label must also be taken from the receiving component and inserted into the holding device within a predetermined time period. It is therefore checked whether, after the removal of a container, a label has been removed from the receiving component within this time period. If not, an error report is output.

Conversely it is automatically identified whether or not a label has been removed from the receiving component. If not, a container must also be removed from the location within a predetermined time period. It is therefore checked whether, after the removal of a label, a container has been removed from the location. If not, an error report is output.

### BRIEF DESCRIPTION OF THE SEVERAL VIEWS OF THE DRAWINGS

The novel features and method steps characteristic of the invention are set out in the claims below. The invention itself, however, as well as other features and advantages thereof, are best understood by reference to the detailed description, which follows, when read in conjunction with the accompanying drawings, wherein:

FIG. 1 shows an initial status before a transport container is loaded and labels are written;

FIG. 2 shows the status after the labels have been inserted into fixed receiving components and before the transport containers are loaded;

FIG. 3 shows the status after both labels have been written and a transport container has been loaded;

FIG. 4 shows the status after the incorrect label has been inserted into the holding device of the loaded container; and

FIG. 5 shows the status after the transport container with the incorrect label has been taken from the positioning surface.

### DETAILED DESCRIPTION OF THE INVENTION

In the exemplary embodiment the invention is used to remove a stack of mail items from a sorting unit. The stack functions as an object, which is to be transported to a destination address in a transport container. The mail items are to be transported in the transport container by a logistics service provider.

The sorting unit operates in a distribution center and has a number of output boxes, in which the sorting unit outputs mail items. Mail items for a specific delivery area are output in each mail box respectively. The sorting unit assigns a destination address to each output box respectively. This assignment can be a permanent (static) assignment or a temporary (dynamic) assignment.

A positioning surface for a container is assigned to each output box. It is possible for the same positioning surface to be assigned to different output boxes, which are emptied one after the other. To receive mail items for the delivery area of the output box, an operator positions a container on this positioning surface and places the mail items from the output box in said container. It is also possible for the sorting unit to output the mail items for the delivery area directly into a container standing on the positioning surface of the output box.

All the mail items the sorting unit outputs into a specific output box are intended for a specific delivery area. It is therefore necessary to specify this delivery area for the further transport of the container, in which mail items from this output box are contained. This delivery area has a delivery address, to which the container containing the mail items is to be transported. This destination address is, for example, a specific destination distribution center, which is responsible for the delivery area. The container containing the mail items can only be transported to the correct destination address, if it displays the destination address in a form that can be read by a person.

A container filled with mail items is moved by persons during transport and switched, for example, from one transport means to another. For example, it is carried from a container transporter to a truck. In the exemplary embodiment it is not necessary for a person moving the container to carry a reading device to read from an electronic data storage unit. Rather it is ensured that the container displays the destination address in a form that can be read by persons, in other words using letters and/or numbers.

Every positioning surface also has a positioning surface sensor. This positioning surface sensor determines whether or not a container is present on the positioning surface. The sensor can operate automatically and, for example, determine the loading of the positioning surface due to the weight of a container. Or an operator activates an activation element, thereby confirming that they have positioned a container on the positioning surface.

In the exemplary embodiment a number of electronic labels are used. Each container has a holding device for an electronic label. This holding device is located on the outside on a side wall of the container and is attached in such a manner that it is able to hold a label securely. The holding device holds a label so that the display element can be read by a person during transport. The holding device prevents the label becoming inadvertently separated from the container during transport. It also holds the label so that an operator can insert a label into the holding device and conversely can remove an inserted label from the holding device. For example, the holding device holds the label securely by means of a snap lock.

Each electronic label comprises a data storage unit, in which at least the following information can be stored in the exemplary embodiment:
a unique identifier for the label, this identifier distinguishing the label from all other electronic labels of the logistics service provider, and
an identifier for the destination address, to which the container is to be transported.

The stored label identifier generally remains unchanged.

Each label comprises a receive unit to receive a container identifier and a destination address in electronic form from a transmit device, and a display element, on which the label displays the stored destination address in a form that can be read by a person.

This display element preferably has a liquid crystal screen, on which the destination address is displayed. Each electronic label preferably operates in a bistable manner, in other words it is able to display the destination address without consuming electrical energy to do so. Electrical energy is only required to write a new destination address into the data storage unit and to generate the readable display on the display element. Therefore the container with the holding device does not have to have an external supply of electrical energy nor does it need to have its own voltage source.

Electronic labels of this type are known, for example, from DE 102004037363 A1, DE 102004037364 A1 and DE 102004037365 A1.

In one refinement it is also possible to use the data storage unit of the label to store information indicating the container into which said label is to be inserted. In this refinement the data storage unit can also store a unique identifier for a container. This identifier distinguishes the container from all other containers of the logistics service provider. The container identifier, which is stored in the data storage unit of the label, changes whenever the label is inserted into the holding device of another container.

The sorting unit also comprises at least one transmit device. The number of transmit devices is preferably significantly lower than the number of output boxes, so that one transmit device is assigned to a number or even all of the output boxes. “Assigned” here means that the transmit device is able to write those labels, which will later identify those containers, in which mail items from one of the assigned output boxes are transported.

A receiving component for receiving a label is also assigned to each output box. Each receiving component is able to receive a label temporarily. An operator inserts a label into the receiving component and removes the label again, once the transmit device has written the label.

In the exemplary embodiment just one receiving component is assigned to each output box. “Assigned” here means that those labels, which will later identify those containers in which mail items from the assigned output box are transported, are inserted into the receiving component.

The receiving component is preferably located in the vicinity of the assigned output box, for example, above the output box, so that an operator can identify immediately which receiving component belongs to which output box.

The receiving component is preferably disposed in such a manner that the display element of a label can be read, while the receiving component receives the label and the transmit device writes the label. This allows a person to check the result of the writing operation immediately. A further advantage is that the written label displays the destination address for the container to an operator. The invention therefore has no need for a fixed display surface for the destination address. The fixed receiving component can therefore be attached where a fixed display surface might otherwise be. The display element of the label in the receiving component instead operates as a display surface for the destination address at the same time.

Each transmit device is configured to transmit a computer-accessible destination address to an electronic label and to store this destination address in the data storage unit of the label. The destination address is generated, for example, by a generation unit GU of the sorting unit and transmitted to the transmit device. One or more receiving components is/are assigned to each transmit device.

The transmit device is able to carry out the transmission operation, when the label is present in a receiving component assigned to the transmit device.

In one refinement the transmit device has a single antenna. This one antenna of the transmit device is disposed in such a manner that the transmit device reaches all the assigned receiving components by way of its antenna. The transmit device uses the label sensors to decide how it uses the one antenna to reach the correct receiving component at the time.

In another refinement one antenna of the transmit device is assigned respectively to each receiving component. There is therefore the same number of antennas as receiving components. One transmit device activates a number of antennas. The assigned antenna is located in the vicinity of the receiving component. It functions as a write head, which writes a label in the receiving component. Because the transmit device “knows” the receiving component in which the label to be written at that time is present, and knows the assignments of antennas to receiving components, the transmit device therefore also “knows” which antennas it has to activate to write this label.

Various combined forms are also possible, for example, where the transmit device has half as many antennas as there are receiving components and each antenna is assigned to two receiving components respectively.

In one refinement the transmit device is also able to read the identifier of a label, which is present in the receiving component. To this end the transmit device is connected to a suitable read device, for example, a read device for RFID chips. The transmit device carries out a read operation to determine automatically whether there is any electronic label in the correct position for writing in this receiving component. If so, the transmit device “knows” which label is then present in this receiving component.

Because the sorting unit has assigned a destination address temporarily or permanently to each output box, the sorting unit “knows” which destination address the transmit device has to transmit in each instance to a label. This destination address is the destination address, to which the mail items in the output box are to be transported.

Each receiving component comprises a label sensor. The label sensor determines whether or not a label has been inserted into the receiving component.

In the simplest instance the label sensor only determines the presence or non-presence of a label in the assigned receiving component. It is however also possible for the label sensor to be configured as a read device and to be able to read from the data storage unit of the label.

In one embodiment an electronic label is assigned permanently to each container. The container identifier is stored in the data storage unit of the label and not changed. A container transports mail items from one output box today and from a different output box of the same or a different sorting unit tomorrow. Because the container is transported, the destination address therefore changes constantly, generally before each transport process.

At the start of the method an empty container and the electronic label assigned to this container are transported to an output box of the sorting unit. This transport operation is carried out by an operator or even by an automatic handling machine. In one refinement the label is inserted into the holding device of the container. In another refinement the container and label are transported separately to the output box.

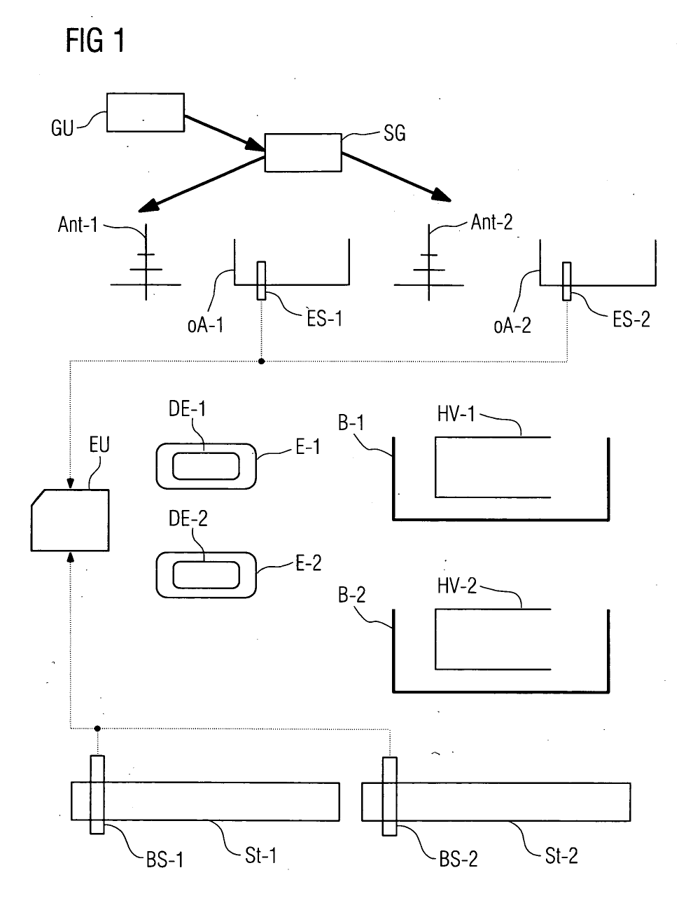

FIG. 1 illustrates this other refinement and shows the initial status before the transport container is loaded and the labels are written. It shows a transmission facility with two antennas Ant-1 and Ant-2 and a control device SG. It also shows two fixed receiving components oA-1 and oA-2 for receiving electronic labels. Two transport containers B-1 and B-2 and two electronic labels E-1 and E-2 are brought to the device separately. The electronic label E-1 has a display element DE-1 for displaying the address in a human-readable type, and the electronic label E-2 has a display element DE-2. The transport container B-1 has a holding device HV-1 for a label, the transport container B-2 a holding device HV-2. Two positioning surfaces St-1 and St-2 are provided for standing containers. Two label sensors ES-1 and ES-2 indicate whether there is a label present in the fixed receiving components oA-1 and oA-2. Two container sensors BS-1 and BS-2 indicate whether or not a transport container is present on the positioning surfaces St-1 and St-2. The two label sensors ES-1 and ES-2 as well as the two container sensors BS-1 and BS-2 are connected with an evaluation unit EU of the sorting unit.

In another embodiment a label is only assigned to each container for the period of a transport operation. With this embodiment a set of containers and a set of labels are provided together or separately. The operator takes a container and label as required. The steps described below are implemented.

The sorting unit reports repeatedly that an output box is to be emptied, for example, because this output box is full or a predetermined time condition is satisfied. The operator or automatic handling machine inserts the label into the receiving component assigned to this output box.

The evaluation unit EU receives measurement signals from each label sensor and determines when a label has been inserted into which receiving component. The evaluation unit EU “knows” the output box to which this receiving component is assigned. The evaluation unit EU also “knows” the destination address, to which a container containing the mail items of this output box is to be transported.

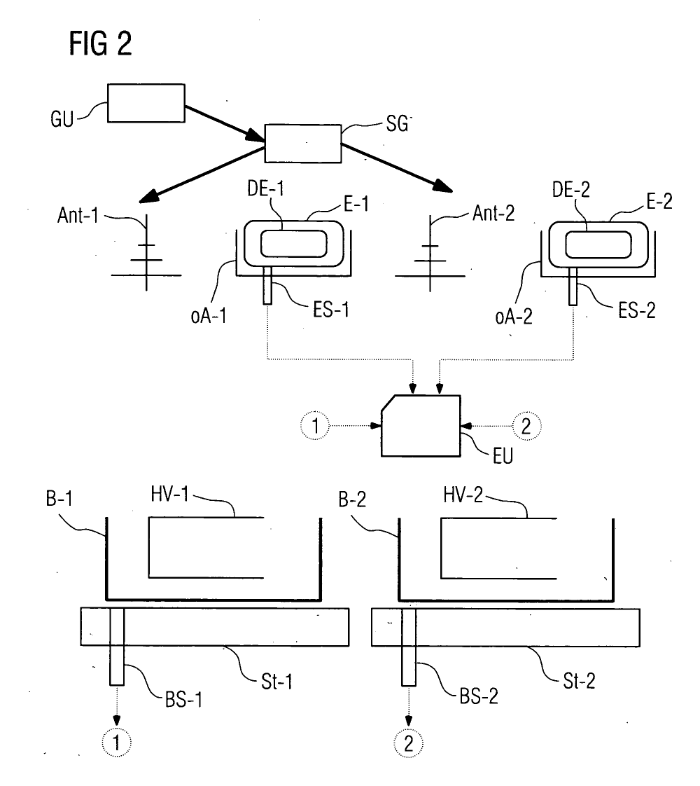

FIG. 2 shows the status after the labels have been inserted into the fixed receiving components and before the transport containers have been loaded. The label E-1 is located in the fixed receiving component oA-1, the label E-2 in the fixed receiving component oA-2. The label sensors ES-1 and ES-2 report to the evaluation unit EU that there are labels present in these receiving components oA-1 and oA-2. The container sensors BS-1 and BS-2 report to this evaluation unit EU that containers are present on the positioning surfaces St-1 and St-2.

Once the evaluation unit EU has determined that a label has been inserted into a receiving component, in one refinement the evaluation unit EU initiates the process wherein the transmit device tries to read the unique identifier of the label in the receiving component. It is also possible for this process to be initiated by the operator pushing a button. If the reading operation is successful, it is determined that an electronic label has actually been inserted into the receiving component and is in the correct position. The transmit device has then identified a specific label.

Once the transmit device has identified the label, it transmits the destination address, to which the container containing the mail items in the output box is to be transported. As set out above, the evaluation unit EU “knows” this correct destination address for the mail items of the output box. The evaluation unit EU transmits this destination address to the transmit device. The transmit device transmits this destination address to the label in the receiving component and stores it in its data storage unit. The transmit unit also uses the antenna functioning as a write head to write the destination address to the display element of the label. The destination address is then stored in the label both in a computer-accessible form and in a form that can be read by a person. The computer-accessible form is held in the data storage unit of the label, the readable form on the display element.

The length of time it takes to write the destination address to the display element is primarily a function of the distance between antenna and label as well as the transmit power, field strength and characteristics of the antenna. Writing can take up to 30 seconds.

Once the transmit device has written the destination address to the display element, the display element informs the operator of the destination address to which this container is to be transported. This refinement of the invention therefore does not require a fixed display surface for the destination address in the vicinity of the output box.

The operator—or the automatic handling machine—loads the container with the mail items in the output box. It is also possible for the sorting unit to output the mail items directly into the container. While the container is being loaded, the transmit device writes the label, as described above. This parallel working has the advantage that writing the label does not cause any time delays. Because the transmit device is part of the sorting unit, the operator does not need to carry a mobile transmit device to write the destination address on the label.

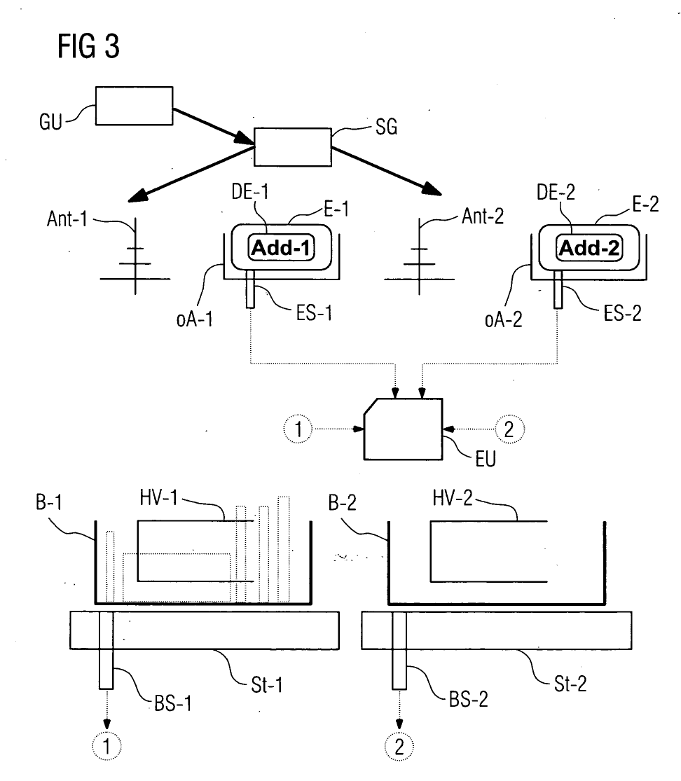

FIG. 3 shows the status after both labels have been written and the transport container B-1 has been loaded. The label E-1 is marked with the destination address Add-1, the label E-2 with the destination address Add-2. A number of mail items are shown in the transport container B-1.

While the transmit device is writing the label, the label is present in the fixed receiving component and not in the holding device on the container. It is therefore possible to attach the transmit device a sufficiently large distance away from the positioning surface and to ensure a good screen between the antenna of the transmit device and the positioning surface. This prevents the health of an operator loading a container standing on the positioning surface being endangered by the radiation from the transmit device. It also prevents an object in the container being heavily irradiated.

It is also possible to equip the transmit device with a sufficiently large transmit power, to allow fast writing. Because the transmit device is preferably attached in a fixed manner to the sorting unit, the transmit device can be significantly larger and heavier than a mobile transmit device. When a fixed transmit device is used, the risk of the transmit device being dropped, lost or stolen is also less compared with a mobile transmit device.

The transmit device preferably outputs a report as soon as the writing process is completed. This report can consist, for example, of an acoustic signal or can even consist of the label displaying the destination address in full on the display element.

Once the container has been loaded and the label has been written, the operator removes the label from the receiving component. The label sensor records the removal of the label from the receiving component. Alternatively the operator can push a button to register removal. The operator inserts the written and removed label into the holding device of the container. The operator—or the automatic handling machine—takes the container from the positioning surface assigned to the output box. The positioning surface sensor registers that the container has been taken from the positioning surface. The signals from the two sensors are used to check whether a written label has been inserted into the correct container, as described in more detail below.

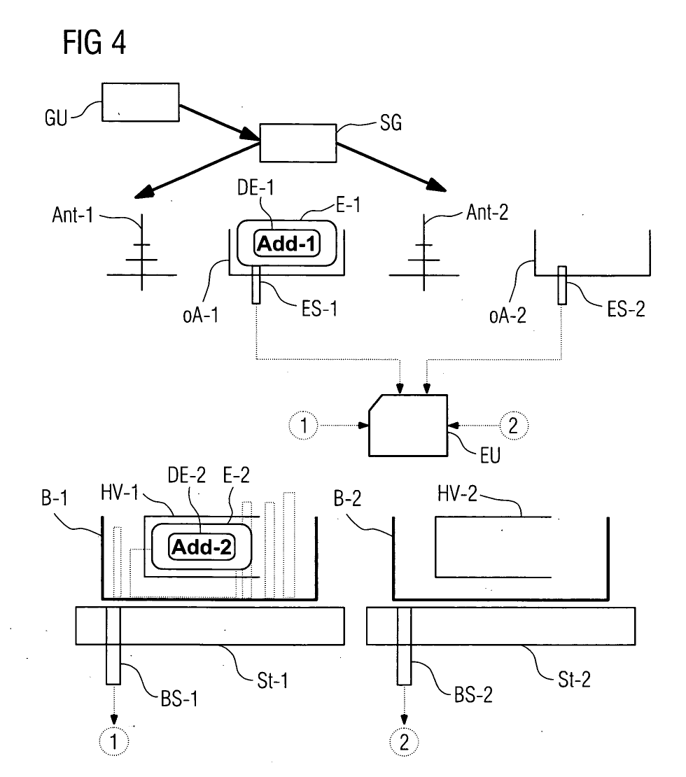

FIG. 4 shows the status after the wrong label has been inserted into the holding device HV-1 of the loaded container B-1, specifically the label E-2 with the destination address Add-2. The label sensor ES-2 reports that there is no label in the fixed receiving component oA-2. In contrast the container sensor BS-2 still reports that there is a container on the positioning surface St-2. When a time period has elapsed, the evaluation unit EU identifies an error and reports the following: The label which was previously present in oA-2 and is marked with the destination address Add-2 is in the wrong container.

The operator—or the automatic handling machine—starts to transport the container to the destination address. For example, the container is placed on a conveyor belt or in a container transporter. The label with the destination address shows a person the destination address. During a switching operation, for example, the destination address informs an operator of the container transporter into which the container is to be transported.

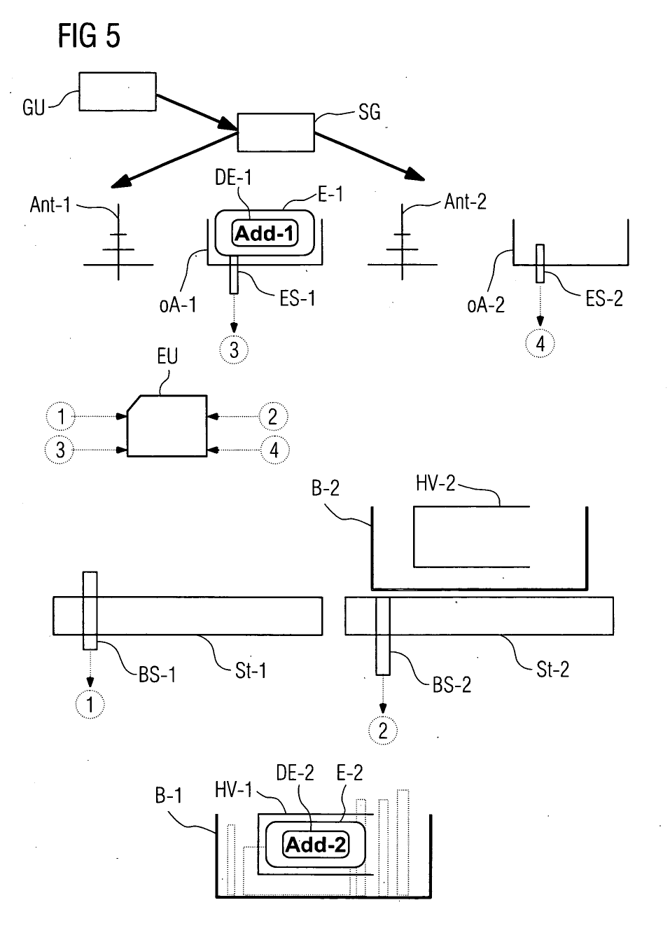

FIG. 5 shows the status after the transport container B-1 with the incorrect label E-2 has been taken from the positioning surface St-1. The container sensor BS-1 reports that there is no container present on the positioning surface St-1. In contrast the label sensor ES-1 still reports that there is a label present in the fixed receiving component oA-1. When a time period has elapsed, the evaluation unit EU identifies an error and reports the following: The container which was previously present on St-1 and is to be transported to the destination address Add-1 has been given an incorrect label.

A read device is also able to read automatically from the data storage unit of the label repeatedly during transport. As a result the read device determines the stored destination address and also the identifier of the container. The read destination address is used to control the further transport of the container, when an automatic machine, for example, an automatic handling machine continues the transport operation. The destination address can also be used to verify whether the container is still on the correct route, for example, whether it is actually in a vehicle driving to the stored and displayed destination address. The read identifier of the container is used to track the route of the container over a number of transport operations. The identifier and the current location of the read device are transmitted to a central computation system. This central system knows where the container is currently located and for how long it has been used. It is possible, for example, to monitor the period of use and the overall transport route of the container.

The evaluation unit EU of the sorting unit preferably determines automatically whether the written label has actually been inserted into the correct holding device. The correct holding device is the holding device of the container, in which the mail items from the output box were placed. When correctly inserted, the label displays the correct destination address for the container.

This evaluation unit EU is connected to the label sensor ES-1 and the corresponding BS-1. They register the time, when the label sensor of an output box detects and reports the removal of a label from the receiving component, and the time when the positioning surface sensor registers that a container has been taken from the positioning surface of this output box.

The evaluation unit EU determines the time difference between these two times and compares this time difference with a predetermined time period. If the time difference is too long, the evaluation unit EU generates an error report, which is output on a suitable signaling unit. The evaluation unit EU also generates a report, if one of the two sensors reports a removal but the other sensor has reported no removal after the time period has elapsed and also reported no removal before the removal report of the first sensor.

In both instances the container has not been provided with a label at all or has been provided with a label from another receiving component. In the first instance the container does not have a label and therefore it does not have a destination address. In the second instance a label with an incorrect destination address has been inserted into the holding device of the container.

In another embodiment an electronic label is not assigned to a container permanently but just for the duration of a transport process. In this embodiment each container is permanently provided with a data medium, on which the identifier of the container is stored. This data medium can simply be a bar code, which is adhered to or printed on the container. The data medium can also be a transponder of an RFID system, which can be read automatically.

In one refinement at least one read device for such data mediums is also provided on containers. This read device can be attached in a fixed manner to the transmit unit. For example, a read device is assigned to each positioning surface. It is also possible for an operator to carry such a read device.

This read device is able to read the identifier of a container standing on the positioning surface and as a result to determine which container is present on the positioning surface.

The evaluation unit EU is connected both to the positioning surface sensors and to the read device(s). The evaluation unit EU is therefore able to determine when which container was placed on which positioning surface.

This embodiment allows the containers and electronic labels to be transported separately to the sorting unit. The labels are located in a dispenser, for example. An operator—or an automatic handling machine—stands an empty container on the positioning surface of an output box and inserts any label into the receiving component. The read device assigned to the output box reads the data medium of the container and thereby determines which container has been placed on the positioning surface.

In one embodiment the transmit device stores the read container identifier in the data storage unit of the label in addition to the destination address. As a result the label “knows” the container for which it is to display the destination address. If the label is inserted into the correct holding device, the label then “knows” the container on which it is currently located.

As with the first embodiment the transmit device also stores the destination address in the data storage unit of the label and writes this destination address to the display element of the label. The other steps also correspond in the other embodiment to the corresponding steps of the first embodiment.

In a third embodiment the containers are not distinguished at all. There is therefore no provision for container identifiers. With the third embodiment it is then not possible automatically to track the route of the container as it is being transported to the destination address.

The third embodiment is therefore simpler. Only the respective destination address is stored in the data storage unit of the label, not the container identifier. The transmit device, which is assigned to an output box, stores the destination address in the data storage unit of an inserted label as described above and writes this destination address to the display element of the label. A person is able to read the destination address on the display element. A read device is able to read out the stored destination address.

We claim:

1. A device for applying a predetermined destination address to a transport container configured to transport an object, comprising:
at least one electronic label configured to store the destination address;
a holding device attached to the transport container configured to hold the electronic label during transport;
a fixed transmission facility for transmitting the destination address to the electronic label and for storing the destination address in the label; and
a fixed receiving component for receiving one of the labels, wherein the receiving component is disposed in such a manner that the transmission facility is configured to transmit the destination address to each of the labels, when the label is received by the fixed receiving component,
wherein the at least one label is removable from the holding device.

2. The device of claim 1, further comprising a label sensor to sense whether or not one of the labels is present in the receiving component, wherein the label sensor is coupled to the transmission facility so that insertion of one of the labels into the receiving component initiates transmission of the destination address to the label by means of the transmission facility.

3. The device of claim 1, further comprising:
a container holding component for holding the transport container while the object is placed in the transport container;
a container sensor for sensing whether or not the container holding component is holding a transport container; and
a label sensor for sensing whether or not one of the labels is present in the receiving component.

4. The device of claim 3, further comprising an evaluation unit connected to both sensors and configured to process measurements from the container sensor to determine whether or not a transport container has been removed from the container holding component, and to process measurements from the label sensor to determine whether or not within a predetermined time period before or after removal of a transport container from the container holding component a label has been removed from the receiving component.

5. The device of claim 3, further comprising an evaluation unit connected to both sensors and configured to process measurements from the label sensor to determine whether or not one of the labels has been removed from the receiving component, and to process measurements from the container sensor to determine whether or not within a predetermined time period before or after removal of a label from the receiving component a transport container has been removed from the container holding component.

6. The device of claim 1, wherein at least one electronic label has a display element for displaying the destination address in human-readable form, and wherein the transmission facility is configured to write the destination address to the display element so that the display element displays the destination address in the human-readable form.

7. The device of claim 6, wherein the display element is configured to display the destination address without consuming electrical energy for this purpose.

8. The device of claim 7, wherein the display element comprises a liquid crystal screen for displaying the destination address.

9. The device of claim 1, wherein the receiving component is disposed so that the label displays the destination address, when the label is received by the receiving component.

10. The device of claim 1, further comprising a number of fixed receiving components, wherein the transmission facility is configured to transmit the destination address to a label when one of the labels is present in one of the receiving components.

11. A unit for bringing about the transport of an object in a transport container to a predetermined destination address, comprising:
a container holding component for holding the transport container while the object is being placed into the transport container;
a generation unit for generating a computer-accessible coding of the destination address; and
a device for applying a destination address to the transport container, wherein the device comprises:
at least one electronic label configured to store the destination address;
a holding device attached to the transport container configured to hold the electronic label during transport;
a fixed transmission facility for transmitting the destination address to the electronic label and for storing the destination address in the label; and
a fixed receiving component for receiving one of the labels, wherein the receiving component is disposed in such a manner that the transmission facility is configured to transmit the destination address to each of the labels, when the label is received by the fixed receiving component.

12. A method for applying a destination address to a transport container, comprising:
placing an object in a transport container;
inserting an electronic label into a fixed receiving component;
transmitting the destination address from a fixed transmission facility to an electronic label while the label is present in the receiving component;
storing the destination address in the label while the label is present in the receiving component;
removing the label from the receiving component; and
inserting the label with the stored destination address into a holding device attached to the transport container.

13. The method of claim 12, wherein the transport container is present in a container holding component while the object is being placed in the transport container, the method further comprising repeatedly sensing with a container sensor whether or not a transport container is present in the container holding component, and repeatedly sensing with a label sensor whether or not an electronic label is present in the receiving component.

14. The method of claim 13, further comprising:
evaluating measurements from the container sensor to determine whether or not a transport container has been removed from the container holding component; and
evaluating measurements from the label sensor to determining whether or not, within a predetermined time period before or after the removal of a transport container from the container holding component a label has been removed from the receiving component.

15. The method of claim 14, further comprising:
evaluating measurements from the label sensor to determine whether or not a label has been removed from the holding component; and
evaluating measurements from the container sensor to determine whether or not, within a predetermined time period before or after the removal of a label from the receiving component a transport container has been removed from the container holding component.
